(19) United States
(12) Patent Application Publication
(10) Pub. No.: US 2023/0391802 A1
(43) Pub. Date: Dec. 7, 2023

(54) PROCESS FOR SYNTHESIZING ALKOXY GROUP-CONTAINING AMINOSILOXANES

(71) Applicant: WACKER CHEMIE AG, Munich (DE)

(72) Inventors: Niklas Wienkenhöver, München (DE); Richard Weidner, Burghausen (DE)

(73) Assignee: Wacker Chemie AG, Munich (DE)

(21) Appl. No.: 18/032,211

(22) PCT Filed: Oct. 20, 2020
(86) PCT No.: PCT/EP2020/079492

§ 371 Date: Apr. 17, 2023

(51) Int. Cl. C07F 7/18; B01J 35/12; B01J 31/02

(52) U.S. Cl. CPC C07F 7/1892; B01J 35/12; B01J 31/0211

(57) ABSTRACT

Processes for preparing aminosiloxanes. The process includes providing an alkoxy-rich partial hydrolyzate of silanes and silane mixtures and reacting the alkoxy-rich partial hydrolyzate of silanes and silane mixtures with one or more aminosilanes in the presence of a basic catalyst

The invention relates to processes for preparing alkoxy-rich aminosiloxanes by equilibrating alkoxy-rich partial hydrolyzates with monomeric aminoalkoxysilanes.

To date, aminosiloxanes rich in alkoxy groups have been produced starting from monomeric methylalkoxysilanes and monomeric aminoalkoxysilanes by base-catalyzed or acid-catalyzed co-hydrolysis. Here, due to the presence of the basic amino functionalities during the hydrolysis, there is in principle the risk of solid formation or even gelation due to the acceleration of the condensation reactions of silanol groups at elevated pH. In addition, solvent additives are necessary to make the exothermic hydrolysis reaction controllable—these additives, however, significantly reduce the space-time yield of the product synthesis.

U.S. Pat. No. 9,962,327 B2 describes a liquid formulation comprising the product from the cohydrolysis of
3-aminopropyltriethoxysilane and methyltriethoxysilane.

EP1580215 A1 describes the preparation of amino-functional organopolysiloxanes by reacting aminosilanes with linear siloxanes and basic catalysts.

The invention relates to a process for preparing aminosiloxanes, in which an alkoxy-rich partial hydrolyzate of silanes independently selected from the general formulae I, Ia, Ib and II

[R¹₃Si(OR²)] (Ia),

[R¹₂Si(OR²)₂] (Ib),

[Si(OR²)₄] (I) and

[R¹Si(OR²)₃] (II)

is reacted with one or more aminosilanes independently selected from the general formulae IIIa to Va or a partial hydrolyzate thereof

[R^{3a}Si(OR⁴)₃] (IIIa),

[R^{3a}₂Si(OR⁴)₂] (IVa) and

[R^{3a}₃Si(OR⁴)] (Va)
in the presence of
a basic catalyst,
where
R¹ is a monovalent C₁-C₂₀-hydrocarbon radical which is unsubstituted or substituted by halogen atoms,
R² and R⁴ may be the same or different and are a hydrogen atom or C₁-C₂₀-hydrocarbon radical which is unsubstituted or substituted by halogen atoms,
R^{3a} is a monovalent C₁-C₂₀-hydrocarbon radical comprising one or more basic nitrogen atoms, or a monovalent C₁-C₂₀-hydrocarbon radical which is unsubstituted or substituted by halogen atoms.

The invention also relates to a process for preparing aminosiloxanes, in which alkoxy-rich partial hydrolyzate of silanes independently selected from the general formulae I and II

[Si(OR²)₄] (I) and

[R¹Si(OR²)₃] (II)

is reacted with one or more aminosilanes independently selected from the general formulae III to V

[R³Si(OR⁴)₃] (III),

[R³₂Si(OR⁴)₂] (IV) and

[R³₃Si(OR⁴)] (V)
in the presence of
a basic catalyst,
where
R¹ is a monovalent C₁-C₂₀-hydrocarbon radical which is unsubstituted or substituted by halogen atoms,
R² and R⁴ may be the same or different and are a hydrogen atom or C₁-C₂₀-hydrocarbon radical which is unsubstituted or substituted by halogen atoms,
R³ is a monovalent C₁-C₂₀-hydrocarbon radical comprising one or more basic nitrogen atoms.

In the process, the hydrolysis of the silanes (condensation reaction) and the amine incorporation via the aminosilanes are separated from each other. The silanes are first converted to partial hydrolyzates by hydrolysis. In the context of this invention, partial hydrolyzates are products of the reaction of silanes or silane mixtures of the general formulae I, Ia, Ib, II, III to V and IIIa to Va with water, in which a substoichiometric amount of water is reacted, relative to the amount of substance required for complete hydrolysis of all alkoxy functionalities, and as such still contain alkoxy functionalities. For the hydrolysis of one mole of alkoxy groups OR² or OR⁴, 0.5 mol of water are required. The amino functionalities are incorporated by base-catalyzed equilibration between the partial hydrolyzates and a monomeric aminoalkoxysilane. The average degree of condensation of the mixture of partial hydrolyzate and aminoalkoxysilane remains unchanged after equilibration.

The process does not require the addition of solvents, which are often necessary to control basic cohydrolyzates. The volume saved in this way means that higher space-time yields can be achieved. Desired solvents for the end application can then subsequently be added.

Since this process does not require the addition of water, gelation can be ruled out and the space-time yield can be significantly increased.

In the process of EP1580215 A1, the basic catalyst is used to link OH functionalities (HO-PDMS-OH and HO-glycol or HO-ethylhexane), releasing water. End functionalities are linked there first. In the process according to the invention, on the other hand, bonds in the partial hydrolyzate and the aminoalkoxysilane are broken and reformed by the equilibration without changing the average degree of condensation. In this very rapid and non-exothermic process, the aminosilane is preferentially incorporated. This can be seen in particular in the formation of the methyltrialkoxysilane and the further progressive incorporation of the aminosilane (expressed by the equilibration state) in the examples. This is surprising due to the higher steric demand of the trialkoxysilanes and the branchings in the resin.

Examples of hydrocarbon radicals R¹, R² or R⁴ are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical, and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl and methylcyclohexyl radicals; aryl radicals such as the phenyl, naphthyl, anthryl and phenanthryl radical; alkaryl radicals such as
o-, m-, p-tolyl radicals, xylyl radicals and ethylphenyl radicals; and aralkyl radicals such as the benzyl radical, the α- and the β-phenylethyl radical.

The hydrocarbon radicals R¹ optionally comprise an aliphatic double bond. Examples are alkenyl radicals such as the vinyl, allyl, 5-hexen-1-yl, E-4-hexen-1-yl, Z-4-hexen-1-yl, 2-(3-cyclohexenyl)ethyl and cyclododeca-4,8-dienyl radical. Preferred radicals R¹ having an aliphatic double bond are the vinyl, allyl and 5-hexen-1-yl radical. Preferably, however, at most 1% of the hydrocarbon radicals R¹, especially none, comprise a double bond.

Examples of R¹, R² or R⁴ substituted by halogen atoms are haloalkyl radicals such as the 3,3,3-trifluoro-n-propyl radical, the 2,2,2,2′,2′,2′-hexafluoroisopropyl radical, the heptafluoroisopropyl radical and haloaryl radicals such as the o-, m- and p-chlorophenyl radical.

The radicals R¹, R² or R⁴ are preferably a saturated hydrocarbon radical having 1 to 10, particularly preferably having 1 to 6 carbon atoms.

Preferably, the radical R¹ is methyl, ethyl, n-propyl, isopropyl or phenyl radicals, particular preference being given to methyl or phenyl radical, especially methyl radical.

The radical R² is preferably a methyl or ethyl radical.

In the general formulae III to V, R³ is preferably a radical of the general formula VI

—R⁵—[NR⁶—R⁷—]_{g}NR⁸₂ (VI)
where R⁵ is a divalent linear or branched hydrocarbon radical having 1 to 18 carbon atoms,
R⁶ and R⁸ have the definition of R¹ and hydrogen, and are preferably a hydrogen atom,
R⁷ is a divalent hydrocarbon radical having 1 to 6 carbon atoms and
g is 0, 1, 2, 3 or 4, preferably 0 or 1.

Preferred examples of radicals R³ are:
morpholino-(CH₂)—
H₂N(CH₂)₂NH(CH₂)CH(CH₃)CH₂—
(cyclohexyl)NH(CH₂)₃—
(cyclohexyl)NH(CH₂)—
CH₃NH(CH₂)₃—
(CH₃)₂N(CH₂)₃—
CH₃CH₂NH(CH₂)₃—
(CH₃CH₂)₂N(CH₂)₃—
CH₃NH(CH₂)₂NH(CH₂)₃—
(CH₃)₂N(CH₂)NH(CH₂)₃—
CH₃CH₂NH(CH₂)₂NH(CH₂)₃—
(CH₃CH₂)₂N(CH₂)₂NH(CH₂)₃—, especially
H₂N(CH₂)₃—
H₂N(CH₂)₂NH(CH₂)₃—.

Examples of aminoalkylsilanes are
(3-aminopropyl)dimethoxymethylsilane,
(3-aminopropyl)diethoxymethylsilane,
(3-aminopropyl)trimethoxysilane,
(3-aminopropyl)triethoxysilane,
N-morpholinomethyltrimethoxysilane,
N-morpholinomethyltriethoxysilane,
cyclohexylaminomethyltrimethoxysilane,
cyclohexalaminomethyltriethoxysilane,
[N-(2-aminoethyl)-3-aminopropyl]dimethoxymethylsilane,
[N-(2-aminoethyl)-3-aminopropyl]diethoxymethylsilane,
[N-(2-aminoethyl)-3-aminopropyl]trimethoxysilane,
[N-(2-aminoethyl)-3-aminopropyl]triethoxysilane,
(aminomethyl)dimethoxymethylsilane, (aminomethyl)diethoxymethylsilane,
(aminomethyl)trimethoxysilane,
(aminomethyl)triethoxysilane.

Particular preference is given to
[N-(2-aminoethyl)-3-aminopropyl]dimethoxymethylsilane,
[N-(2-aminoethyl)-3-aminopropyl]diethoxymethylsilane,
[N-(2-aminoethyl)-3-aminopropyl]trimethoxysilane, [N-(2-aminoethyl)-3-aminopropyl]triethoxysilane,
(3-aminopropyl)dimethoxymethylsilane, (3-aminopropyl)diethoxymethylsilane, (3-aminopropyl)trimethoxysilane and (3-aminopropyl)triethoxysilane, and cyclic or linear partial hydrolyzates thereof.

Examples and preferred examples of radicals R^{3a} are listed for radicals R¹ and R³.

The alkoxy-rich partial hydrolyzate of silanes selected from the general formulae I, Ia, Ib and II, particularly I and II, is preferably prepared by hydrolysis of the silanes selected from the general formulae I, Ia, Ib and II, particularly I and II. The hydrolysis can be catalyzed by acids, preferably mineral acids such as hydrochloric acid, phosphoric acid or sulfuric acid.

The alkoxy-rich partial hydrolyzate preferably has 0.1 to 2, particularly preferably 0.3 to 1.7, especially 0.5 to 1.5 alkoxy groups per silicon atom.

In a preferred embodiment, the alkoxy-rich partial hydrolyzate is prepared from at least 70% by weight, particularly preferably at least 90% by weight, especially at least 95% by weight, silane of the general formula II. The remaining silane is silane of the general formula I.

It is possible to use one type of partial hydrolyzate or two or more types of partial hydrolyzates.

The partial hydrolyzates have a viscosity of preferably 10 to 3000 mPa*s at 25° C., preferably 30 to 2000 mPa*s at 25° C.

The partial hydrolyzates have a molar mass Mₙ according to GPC of preferably 100 to 2000 g/mol, preferably 200 to 1500 g/mol.

A commercially available partial hydrolyzate is SILRES® MSE 100 from WACKER CHEMIE AG, Germany.

In the process according to the invention, preferably 10 to 200 parts by weight, particularly preferably 20 to 150, especially 30 to 120 parts by weight of aminosilane are used per 100 parts by weight of partial hydrolyzate.

The reaction is preferably carried out until the composition no longer changes under the reaction conditions.

The basic catalysts are preferably selected from alkali metal and alkaline earth metal hydroxides, alkoxides and siloxanolates. Preference is given to the alkali metal alkoxides.

Preferred examples of the alkali metal hydroxides used in the process according to the invention are potassium hydroxide and sodium hydroxide, with potassium hydroxide being preferred.

Preferred examples of the alkali metal alkoxides used in the process according to the invention are sodium methoxide, sodium ethoxide, potassium methoxide and potassium ethoxide.

Preferred examples of the alkali metal siloxanolates used in the process according to the invention are sodium siloxanolates.

In the process according to the invention, based on the partial hydrolyzate, preferably 0.1 to 800 ppm by weight, particularly preferably 10 to 650 ppm by weight and particularly preferably 50-400 ppm by weight of basic catalyst are added.

When using alkali metal alkoxides, especially NaOMe or KOMe, the final equilibrium state, thermodynamic equilibrium, is rapidly established. The material composition no longer changes over time. This could be verified by NMR analysis.

The temperature in the process is preferably from 10 to 150° C., especially 20 to 110° C.

The pressure in the process is preferably 0.01 MPa (abs.) to 1 MPa (abs.), especially 0.05 MPa (abs.) to 0.5 MPa (abs.).

Neutralizing agents are preferably used at the end of the reaction to deactivate the basic catalyst.

Examples of such neutralizing agents used are acids, for example mineral acids such as hydrochloric acid, phosphoric acid or sulfuric acid; triorganosilyl phosphates such as trimethylsilyl phosphates; carboxylic acids such as n-octanoic acid, 2-ethylhexanoic acid, n-nonanoic acid and oleic acid; carbonic acid esters such as propylene carbonate; or carboxylic anhydrides such as octenylsuccinic anhydride. In a particularly preferred embodiment, acids are used for the neutralization, the salts of which are soluble at 20° C. in the aminosiloxanes prepared.

### EXAMPLES

In the following examples, unless otherwise stated in each case, all amounts and percentages are based on weight, all pressures are 0.10 MPa (abs.) and all temperatures are 20° C.

1. Reactants and Measurement Methods:

1.1 Alkoxysilanes

a) GENIOSIL® GF 93: 3-aminopropyltriethoxysilane (CAS: 919-30-2) from Wacker Chemie AG, with a purity of at least 97% (AS1).

b) GENIOSIL® GF 96: 3-aminopropyltrimethoxysilane (CAS: 13822-56-5) from Wacker Chemie AG, with a purity of at least 95% (AS2).

c) SILANE M1-TRIETHOXY: methyltriethoxysilane (CAS: 2031-67-6) from Wacker Chemie AG, with a purity of at least 97%.

d) SILANE M1-TRIMETHOXY: trimethoxymethylsilane (CAS: 1185-55-3) from Wacker Chemie AG, with a purity of at least 97%.

e) SILANE P-TRIETHOXY: triethoxyphenylsilane (CAS: 780-69-8) from Wacker Chemie AG, with a purity of at least 98%.

f) SILRES® MSE 100: methoxy-functional methylpolysiloxane resin from Wacker Chemie AG, having a viscosity of 20-35 mm²/s.

1.2 Other Chemicals

Trimethoxyphenylsilane (CAS: 2996-92-1), concentrated hydrochloric acid (acid 1), isotridecyl phosphate (acid 2), 2-butyloctanoic acid (acid 3), methanol (HPLC grade), ethanol (HPLC grade), sodium methoxide, sodium ethoxide, potassium ethoxide and potassium hydroxide were sourced from common suppliers. The solutions of the alkali metal alkoxides and of potassium hydroxide used in the examples were produced starting from the solids using the pure alcohols mentioned above.

1.3 Viscosity:

The measurement of the viscosities of the materials in the context of the present invention was carried out with temperature control at

25° C. using a Stabinger rotational viscometer SVM3000 from Anton Paar at 25° C. (standard).

1.4 Gel Permeation Chromatography:

The mass-average molar mass M_{w} and also the number-average molar mass Mₙ are determined by size exclusion chromatography (SEC) against polydimethylsiloxane standards, in toluene, at 35° C., flow rate 0.7 ml/min and detection by RI (refractive index detector) on a MesoPore-OligoPore column set (Agilent, Germany) with an injection volume of 10 μl.

1.5 NMR Spectroscopy (²⁹Si- and ¹H-NMR)

1.5.1 Average Empirical Formula:

The average composition of the partial hydrolysates according to section 2 was determined by ¹H nuclear magnetic resonance spectroscopy (¹H-NMR; Bruker Avance III HD 500 (¹H: 500.2 MHz) spectrometer with BBO 500 MHz S2 probe head; 50 mg of the relevant sample in 500 μl of CD₂Cl₂). Here, the signal intensities of the Ph, Me, MeO or EtO functionalities are determined and, after normalization to the respective proton number of the individual groups, compared to one another.

1.5.2 Evaluation of the Equilibration State:

The equilibration state of the aminosiloxanes from Examples 1-15 was determined using ²⁹Si nuclear magnetic resonance spectroscopy (²⁹Si-NMR; Bruker Avance III HD 500 (²⁹Si: 99.4 MHz) spectrometer with BBO 500 MHz S2 probe head; inverse gated pulse sequence (NS=3000); 150 mg of the relevant sample in 500 μl of CD₂Cl₂). The intensity ratio between the amino-functionalized monomer introduced and the methyl- or phenyl-functionalized trialkoxysilanes formed during the equilibration reaction is specified. For mixed methoxy/ethoxy systems, i.e. systems in which an ethoxysilane is equilibrated with a methoxysilane, the alkoxy group exchange that occurs during the equilibration reaction must be taken into account. Consequently, the ratio of the sum of the respective related individual components (i.e. resulting from the transalkoxylation) is determined. Using the example of the equilibration of methyltrimethoxysilane with 3-aminopropyltriethoxysilane, the signal intensities of H₂N(CH₂)₃Si(OEt)₃, H₂N(CH₂)₃Si(OEt)₂(OMe), H₂N(CH₂)₃Si(OEt)(OMe)₂, H₂N(CH₂)₃Si(OMe)₃ would be summed up and would be divided by the sum of the signal intensities of the individual components MeSi(OMe)₃, MeSi(OMe)₂(OEt), MeSi(OMe)(OEt)₂ and MeSi(OEt)₃. The value thus obtained is subtracted from 1. The result is stated in %.

To be able to clearly identify the mixed methoxy/ethoxy compounds by ²⁹Si-NMR, two reference experiments were carried out in advance.

1.5.3 Identification of Me(OEt)₂(OMe)Si and Me(OEt)(OMe)₂Si

In the first experiment, equimolar amounts of methyltriethoxysilane and methyltrimethoxysilane were mixed. 300 ppm by weight of a sodium methoxide solution (30% by weight in methanol) was added and the mixture was heated to 60° C. for one hour. 100 mg of this mixture were mixed with 900 mg of the partial hydrolyzate from Example 2 and a ²⁹Si NMR spectrum of a sample of this mixture was recorded in CD₂Cl₂.

1.5.4 Identification of RSi(OEt)₂(OMe)Si and RSi(OEt)(OMe)₂Si

In further separate experiments, equimolar amounts of the related aminotriethoxysilanes and aminotrimethoxysilanes (where R═H₂N(CH₂)₃— and H₂N(CH₂)₂NH(CH₂)₃—) were mixed. 300 ppm by weight of a sodium methoxide solution (30% by weight in methanol) was added and the mixture was heated at 60° C. for one hour. 100 mg of this mixture were mixed with 900 mg of the partial hydrolyzate from Example 2 and a ²⁹Si NMR spectrum of a sample of this mixture was recorded in CD₂Cl₂.

2. Preparation of Partial Hydrolyzates—Resins A1-A4

2.1 Partial Hydrolyzate of Methyltriethoxysilane (Resin A1)

2238 g of methyltriethoxysilane are initially charged in a 4 L three-necked flask equipped with a KPG stirrer and a 500 mL pressure-equalizing dropping funnel. With intensive stirring, 266.8 g of deionized water are added dropwise over a period of one hour via the dropping funnel. The mixture is then stirred at room temperature for one hour. The adhering ethanol is removed by distillation at 40° C. and 145 mbar in a rotary evaporator. After filtration through a fluted filter, a clear, colorless fluid is obtained. According to ¹H and ²⁹Si-NMR spectra in CD₂Cl₂, this product is a mixture of methyltriethoxysilane and other (ethoxy-functionalized) methylsiloxanes having an average composition of MeSi(OEt)_{0.64}, a viscosity of 33.2 mPa*s, a density of 1.090 g/L and a polydispersity of 2.43 (Mₙ: 1024 g/mol, M_{w}: 2492 g/mol). The material obtained is hereinafter referred to as resin A1.

2.2. Partial Hydrolyzate of Methyltrimethoxysilane (Resin A2)

SILRES® MSE 100 from Wacker Chemie AG is used as partial hydrolyzate of methyltrimethoxysilane. The material used had a viscosity of 38.7 mPa*s and an average composition of MeSi(OMe)_{0.84}. The material is hereinafter referred to as resin A2.

2.3 Partial Hydrolyzate of Triethoxyphenylsilane (Resin A3)

1000 g of triethoxyphenylsilane are initially charged in a 2 L three-necked flask equipped with a KPG stirrer and a 500 mL pressure-equalizing dropping funnel. A mixture consisting of 86.1 g of deionized water and 10.1 g of concentrated hydrochloric acid is added dropwise via the dropping funnel over a period of 30 minutes with intensive stirring. The mixture is then stirred at room temperature for two hours. The adhering ethanol is removed by distillation at 60° C. and 70 mbar in a rotary evaporator. A clear, colorless fluid is obtained. According to ¹H and ²⁹Si-NMR spectra, this product is a mixture of ethoxy-functionalized phenylsiloxanes having an average composition of PhSi(OEt)_{0.58}, a viscosity of 1800 mPa*s and a polydispersity of 2.68 (Mₙ: 305 g/mol, M_{w}: 815 g/mol). The material obtained is hereinafter referred to as resin A3.

2.4 Partial Hydrolyzate of Trimethoxyphenylsilane (Resin A4)

1000 g of trimethoxyphenylsilane are initially charged in a 2 L three-necked flask equipped with a KPG stirrer and a 500 mL pressure-equalizing dropping funnel. A mixture consisting of 92.6 g of deionized water and 4.0 g of concentrated hydrochloric acid is added dropwise via the dropping funnel over a period of 30 minutes with intensive stirring. The mixture is then stirred at room temperature for two hours. The adhering methanol is removed by distillation at 40° C. and 100 mbar in a rotary evaporator. A clear, colorless fluid is obtained. According to ¹H and ²⁹Si-NMR spectra in CD₂Cl₂, this product is a mixture of methoxy-functionalized phenylsiloxanes having an average composition of PhSi(OMe)_{0.97}, a viscosity of 377 mPa*s and a polydispersity of 2.00 (Mₙ: 277 g/mol, M_{w}: 555 g/mol). The material obtained is hereinafter referred to as resin A4.

3. Preparation of Aminosiloxanes by Equilibration of Partial Hydrolyzates—General Synthesis Procedure:

In a 1 L or 2 L three-necked flask equipped with a KPG stirrer, a reflux condenser with bubble counter and an olive with an argon connection, the resin and the aminosilane specified in the respective example are first mixed according to the weights in Table 1. The reaction apparatus is then inertized with argon. The catalyst solution (according to the weights in Table 1; ppm by weight are based on the total mass of resin and aminosilane (AS)) is added in the countercurrent of argon. Depending on the example, the material is equilibrated at a specified temperature (see Table 1). The catalyst is neutralized by adding the acid specified in Table 1. When using concentrated hydrochloric acid, equimolar amounts of substance are added to the catalyst. If acids 2 or 3 are used, three times the amount of acid—based on the equimolar amount of substance to the catalyst used—is added in each case. The solid precipitating when using concentrated hydrochloric acid (acid 1) is isolated by filtration through a fluted filter using an argon bell jar. When acids 2 or 3 were used, no precipitation was observed and consequently no filtration was carried out. The weights and synthesis conditions of the examples are shown in Table 1. The analytical data for the products obtained are presented in Table 2.

TABLE 1
Summary of the reactants, catalysts, neutralizing agents, synthesis
conditions and weights used in the examples. The synthesis was carried
out according to the general synthesis procedure in section 3.

| | | | Catalyst | Internal | | |
|---|---|---|---|---|---|---|
| | | | used; weight | temperature [° C.]; | Acid | |
| | Resin used; | Aminosilane | [ppm by | equilibration time | used for | Yield |
| Examples | weight [g] | used; weight [g] | weight*] | [hours] | neutral. | [%] |
| Example 1 | Resin A1; 500 | Silane AS1; 500 | NaOMe; 400 | 100; 2 | Acid 1 | 98.7 |
| Example 2 | Resin A1; 1025 | Silane AS1; 475 | NaOMe; 400 | 100; 2 | Acid 1 | 99.1 |
| Example 3 | Resin A1; 1025 | Silane AS1; 438 | NaOMe; 400 | 100; 2 | Acid 1 | 99.0 |
| Example 4 | Resin A1; 410 | Silane AS1; 160 | NaOMe; 400 | 100; 2 | Acid 1 | 98.0 |
| Example 5 | Resin A1; 410 | Silane AS1; 146 | NaOMe; 400 | 100; 2 | Acid 1 | 98.6 |
| Example 6 | Resin A1; 1025 | Silane AS1; 438 | NaOMe; 400 | 50; 5 | Acid 1 | 98.9 |
| Example 7 | Resin A1; 1025 | Silane AS1; 438 | NaOMe; 400 | 25; 18 | Acid 1 | 98.8 |
| Example 8 | Resin A1; 550 | Silane AS1; 225 | NaOMe; 400 | 100; 2 | Acid 2 | 100 |
| Example 9 | Resin A1; 550 | Silane AS1; 225 | NaOMe; 400 | 100; 2 | Acid 3 | 100 |
| Example 10 | Resin A1; 550 | Silane AS1; 225 | NaOEt; 700 | 100; 2 | Acid 1 | 98.8 |
| Example 11 | Resin A1; 550 | Silane AS1; 225 | KOEt; 780 | 100; 2 | Acid 2 | 100 |
| Example 12 | Resin A1; 550 | Silane AS1; 225 | KOH; 650 | 100; 2 | Acid 2 | 100 |
| Example 13 | Resin A2; 1000 | Silane AS1; 500 | NaOMe; 400 | 100; 2 | Acid 1 | 99.1 |
| Example 14 | Resin A3; 240 | Silane AS1; 103 | NaOMe; 400 | 100; 2 | Acid 1 | 98.6 |
| Example 15 | Resin A4; 342 | Silane AS1; 146 | NaOMe; 400 | 100; 2 | Acid 1 | 98.9 |
| Example 16 | Resin A2; 50 | Silane AS2; 50 | NaOMe; 400 | 100; 2 | Acid 2 | 100 |
| Example 17 | Resin A2; 50 | Silane AS2; 25 | NaOMe; 400 | 100; 2 | Acid 2 | 100 |

*The ppm by weight figure refers to the weight of catalyst solution (30% by weight in methanol for NaOMe, 29% by weight in methanol for KOH, 21% by weight in ethanol for NaOEt and 24% by weight in ethanol for KOEt) based on the total mass of resin and aminosilane. The catalyst solutions were produced from the solids. The solids were weighed out in a glove box.

TABLE 2
Summary of the analytical results of the examples given in Table 1.

| | | GPC | | | Equilibration state |
|---|---|---|---|---|---|
| | Viscosity | Mₙ | M_{w} | Polydis- | according to 1.5.2 |
| Examples | [mPa*s] | [g/mol] | [g/mol] | persity | [%] |
| Example 1 | 6.9 | 171 | 251 | 1.47 | 64.1 |
| Example 2 | 18.9 | 328 | 386 | 1.18 | 86.0 |
| Example 3 | 23.2 | 290 | 403 | 1.39 | 87.5 |
| Example 4 | 29.7 | 295 | 422 | 1.43 | 88.5 |
| Example 5 | 38.0 | 300 | 447 | 1.49 | 90.6 |
| Example 6 | 23.0 | 290 | 403 | 1.39 | 88.7 |
| Example 7 | 23.1 | 291 | 405 | 1.39 | 89.5 |
| Example 8 | 38.4 | 270 | 365 | 1.32 | 87.4 |
| Example 9 | 34.1 | 299 | 415 | 1.39 | 85.8 |
| Example 10 | 35.4 | 323 | 465 | 1.44 | 88.0 |
| Example 11 | 36.9 | 309 | 444 | 1.44 | 85.5 |
| Example 12 | 35.7 | 285 | 382 | 1.34 | 87.4 |
| Example 13 | 14.1 | 281 | 354 | 1.26 | 87.9 |
| Example 14 | 79.0 | 568 | 1243 | 2.19 | 60.3 |
| Example 15 | 42.0 | 374 | 611 | 1.63 | 94.0 |
| Example 16 | 6.3 | 64 | 128 | 1.99 | 54.9 |
| Example 17 | 17.1 | 118 | 270 | 2.29 | 82.4 |

The aminosiloxanes are in the viscosity range of 5-100 mPa*s.

Since the reaction consists only of an equilibration, the total content of alkoxy groups remains the same. A practical consequence is the fact that the methyltrialkoxysilane is also released from the partial hydrolyzate during equilibration. If there were no preferred incorporation of amino groups, the equilibration state would have to be 0%; equimolar parts of methyltrialkoxysilane and aminotrialkoxysilane would then be present. However, since the measured values are typically >85% (with the exception of the examples where larger amounts of aminosilane are used), this quantity demonstrates that the aminosilane is preferentially incorporated during equilibration, which is also surprising here.

1-14. (canceled)

15. A process for preparing aminosiloxanes, comprising:
providing an alkoxy-rich partial hydrolyzate of silanes and silane mixtures independently selected from the general formulae I, Ia, Ib and II
[R¹₃Si(OR²)] (Ia),
[R¹₂Si(OR²)₂] (Ib),
[Si(OR²)₄] (I) and
[R¹Si(OR²)₃] (II);
reacting the alkoxy-rich partial hydrolyzate of silanes and silane mixtures with one or more aminosilanes independently selected from the general formulae IIIa to Va or a partial hydrolyzate thereof
[R^{3a}Si(OR⁴)₃] (IIIa),
[R^{3a}₂Si(OR⁴)₂] (IVa) and
[R^{3a}₃Si(OR⁴)] (Va)
in the presence of a basic catalyst;
wherein R¹ is a monovalent C₁-C₂₀-hydrocarbon radical which is unsubstituted or substituted by halogen atoms;
wherein R² and R⁴ may be the same or different and are a hydrogen atom or C₁-C₂₀-hydrocarbon radical which is unsubstituted or substituted by halogen atoms; and
wherein R^{3a} is a monovalent C₁-C₂₀-hydrocarbon radical comprising one or more basic nitrogen atoms, or a monovalent C₁-C₂₀-hydrocarbon radical which is unsubstituted or substituted by halogen atoms.

16. The process of claim 15, wherein the radical R¹ is selected from methyl radical and phenyl radical.

17. The process of claim 15, wherein the radical R² is selected from methyl radical and ethyl radical.

18. The process of claim 15, wherein the alkoxy-rich partial hydrolyzate is prepared from at least 70% by weight silane of the general formula II.

19. The process of claim 15, wherein the alkoxy-rich partial hydrolyzate has an average molar mass Mₙ according to GPC from 100 to 2000 g/mol.

20. The process of claim 15, wherein 10 to 200 parts by weight of aminosilane are used per 100 parts by weight of partial hydrolyzate.

21. The process of claim 15, wherein the basic catalyst is selected from alkali metal hydroxides and alkaline earth metal hydroxides, alkali metal alkoxides and alkaline earth metal alkoxides and alkali metal siloxanolates and alkaline earth metal siloxanolates.

22. The process of claim 15, wherein the basic catalyst is selected from sodium methoxide, sodium ethoxide, potassium hydroxide, potassium methoxide and potassium ethoxide.

23. The process of claim 15, wherein an acid is used at the end of the reaction to deactivate the basic catalyst.

24. The process of claim 23, wherein an acid is used, the salt of which is soluble in the aminosiloxanes produced at 20° C.

25. The process of claim 15, wherein the reaction is carried out for so long that the composition no longer changes under the reaction conditions.

26. A process for preparing aminosiloxanes, comprising:
providing an alkoxy-rich partial hydrolyzate of silanes independently selected from the general formulae I and II
[Si(OR²)₄] (I) and
[R¹Si(OR²)₃] (II);
reacting the alkoxy-rich partial hydrolyzate of silanes with one or more aminosilanes independently selected from the general formulae III to V
[R³Si(OR⁴)₃] (III),
[R³₂Si(OR⁴)₂] (IV) and
[R³₃Si(OR⁴)] (V)
in the presence of the basic catalyst;
wherein R¹ is a monovalent C₁-C₂₀-hydrocarbon radical which is unsubstituted or substituted by halogen atoms;
wherein R² and R⁴ may be the same or different and are a hydrogen atom or C₁-C₂₀-hydrocarbon radical which is unsubstituted or substituted by halogen atoms; and
wherein R³ is a monovalent C₁-C₂₀-hydrocarbon radical comprising one or more basic nitrogen atoms.

27. The process of claim 26, wherein the radical R² is selected from methyl radical and ethyl radical.

28. The process of claim 26, wherein the radical R³ is a radical of the general formula VI
—R⁵—[NR⁶—R⁷—]_{g}NR⁸₂ (VI);
where R⁵ is a divalent linear or branched hydrocarbon radical having 1 to 18 carbon atoms;
wherein R⁶ and R⁸ have the definition of R¹ and hydrogen; and
wherein R⁷ is a divalent hydrocarbon radical having 1 to 6 carbon atoms and g is 0, 1, 2, 3 or 4.

29. The process of claim 26, wherein the radical R³ is selected from H₂N(CH₂)₃— and H₂N(CH₂)₂NH(CH₂)₃—.

30. The process of claim 26, wherein the alkoxy-rich partial hydrolyzate is prepared from at least 70% by weight silane of the general formula II; or
wherein the alkoxy-rich partial hydrolyzate has an average molar mass Mₙ according to GPC from 100 to 2000 g/mol.

31. The process of claim 26, wherein 10 to 200 parts by weight of aminosilane are used per 100 parts by weight of partial hydrolyzate.

32. The process of claim 26, wherein the basic catalyst is selected from alkali metal hydroxides and alkaline earth metal hydroxides, alkali metal alkoxides and alkaline earth metal alkoxides and alkali metal siloxanolates and alkaline earth metal siloxanolates.

33. The process of claim 26, wherein the basic catalyst is selected from sodium methoxide, sodium ethoxide, potassium hydroxide, potassium methoxide and potassium ethoxide.

34. The process of claim 26, wherein an acid is used at the end of the reaction to deactivate the basic catalyst; or
wherein the reaction is carried out for so long that the composition no longer changes under the reaction conditions.
